(19) United States
(12) Patent Application Publication
(10) Pub. No.: US 2008/0025027 A1
(43) Pub. Date: Jan. 31, 2008

(54) Fluorescent Light Source Comprising Yttria Layer

(76) Inventors: Hyung-Joon Lim, Incheon (KR); Young-Chul Yoo, Kyeongki-Do (KR); Sang-Jin Lee, Kyeongki-Do (KR); O-Sung Kwon, Seoul (KR); Joon-Sung Kwon, Kyeongki-Do (KR)

Correspondence Address: IPLA P.A., 3580 WILSHIRE BLVD., 17TH FLOOR, LOS ANGELES, CA, 90010, US

(21) Appl. No.: 11/572,482

(22) PCT Filed: Jun. 3, 2005
(86) PCT No.: PCT/KR05/01662

§ 371 Date: Jan. 22, 2007

(30) Foreign Application Priority Data
Jul. 23, 2004 (KR) 10-2004-0057767

(51) Int. Cl. F21S 4/00; B05D 5/06

(52) U.S. Cl. 362/260; 427/165

(57) ABSTRACT

Disclosed herein is a fluorescent light source including an yttria layer. Specifically, the current invention provides a fluorescent light source having high quality and a long lifetime, which can prevent a decrease in initial luminance of a fluorescent light source, including a fluorescent lamp, and resist the radiation of ultraviolet light and the permeation of mercury, which are the causes of deterioration of the fluorescent light source, so as not to decrease the luminance in proportion to the lighting time of the fluorescent light source, thus assuring both initial luminance properties and luminance properties after use for a long period of time. Such a fluorescent light source includes glass, a fluorescent material layer, and an absorbing layer composed mainly of yttria particles formed between the glass and the fluorescent material layer or on the inner surface of the fluorescent material layer. In addition, an yttria coating composition used in the fluorescent light source and a method of fabricating the fluorescent light source using the composition are also provided.

### TECHNICAL FIELD

The present invention relates, in general, to a fluorescent light source comprising an yttria layer, and, more particularly, to a fluorescent light source having high quality and a long lifetime, which can prevent a decrease in initial luminance of a fluorescent light source, including a fluorescent lamp, and resist the radiation of ultraviolet (UV) light and the permeation of mercury, which are the causes of deterioration of the fluorescent light source, so as not to decrease the luminance in proportion to the lighting time of the fluorescent light source, thus assuring both initial luminance properties and luminance properties after use for a long period of time, and to an yttria coating composition for use in such a fluorescent light source and a method of fabricating the fluorescent light source using the yttria coating composition.

### BACKGROUND ART

A conventional fluorescent light source, including a general fluorescent lamp, a CCFL (Cold Cathode Fluorescent Lamp), an EEFL (External Electrode Fluorescent Lamp) or an FPL (Flat Panel Lamp), used in BLUs (BackLight Units) for TFT-LCDs (Thin Film Transistor-Liquid Crystal Displays), gradually decreases in its luminance in proportion to a lighting time that is an operation time thereof, and eventually its lifetime becomes exhausted. The causes of decreasing luminance include, for example, blackening of a lamp, aging of a fluorescent material, and decreasing luminous efficiency of the fluorescent material. Moreover, the decrease in luminance results in a shortened lifetime of the fluorescent light source. In addition, if the fluorescent light source must be frequently replaced, economic benefits are negated.

That is, the decrease in luminance of the fluorescent light source occurs for the following three reasons; the first is a blackening phenomenon of the lamp caused by UV light and mercury in the fluorescent light source reacting with Na in glass, the second is an aging phenomenon of the fluorescent material upon exposure to UV light of 185 nm, and the third is low luminous efficiency of the fluorescent material due to the adsorption of mercury included in the fluorescent light source.

In order to solve the above problems and realize a fluorescent lamp having a long lifetime, techniques for controlling the radiation of UV light onto glass and a fluorescent material of the fluorescent light source and the diffusion of mercury into the fluorescent material are required, but improvements thereof have not been devised in practice. To indirectly solve the above problems, borate glass, having a low Na content, serves as a material for glass of the fluorescent light source, thus decreasing the reaction between an Na ion deposit in glass and mercury so as to prevent the blackening. However, this method is not a fundamental solution, and therefore the above problems remain essentially unsolved.

### DISCLOSURE OF INVENTION

### Technical Problem

Accordingly, the present invention has been made keeping in mind the above problems occurring in the related art, and an object of the present invention is to provide a fluorescent light source, which may be prepared using conventional preparation processes of a fluorescent light source to apply the structure of a conventional fluorescent light source, and thus has initial luminance properties the same as those of a conventional light source and also has a long lifetime, and a light source device or a display device comprising the same.

Another object of the present invention is to provide an yttria coating composition for a fluorescent light source, used in the fabrication of the fluorescent light source.

A further object of the present invention is to provide a method of fabricating a fluorescent light source comprising the yttria coating composition.

### Technical Solution

In order to achieve the above objects, the present invention provides a fluorescent light source, comprising glass, a fluorescent material layer, and an absorbing layer composed mainly of yttria (Y₂O₃) formed between the glass and the fluorescent material layer or on the inner surface of the fluorescent material layer.

In addition, the present invention provides an yttria coating composition for a fluorescent light source, comprising yttria, having a maximum particle size not exceeding 1000 nm, and a dilution solvent.

In addition, the present invention provides a method of fabricating a fluorescent light source, comprising:

a) coating an inner surface of glass of the light source or an inner surface of a fluorescent material layer of the light source with the yttria coating composition, to form a coating layer; and

b) heat treating the coating layer to cure it.

### Advantageous Effects

The present invention provides a fluorescent light source, an yttria coating composition for the fluorescent light source, and a method of fabricating the fluorescent light source. According to the present invention, inorganic yttria, through which a bright line of mercury, required for the emission of a fluorescent material among all wavelengths of light emitted by electrical discharge, is passed, in which a UV wavelength range decreasing the lifetime of the fluorescent material is absorbed, and with which the absorption of visible blue light is minimized, is used in an absorbing layer in the form of particles. Thereby, while initial luminance properties of the fluorescent light source are not decreased, the lifetime of the fluorescent light source is prolonged to 50,000˜70,000 hr.

In addition, the yttria layer functions to prevent the diffusion of mercury into glass in an electrical discharge tube, thus resisting the reaction between mercury and sodium included in the glass. Thereby, the reaction between sodium and mercury, causing a blackening phenomenon, does not occur, and thus, the lifetime of the fluorescent light source can be prolonged.

### BRIEF DESCRIPTION OF THE DRAWINGS

FIG. 1 is a sectional view showing a fluorescent lamp of a fluorescent light source, according to a first embodiment of the present invention;

FIG. 2 is a sectional view showing a fluorescent lamp of a fluorescent light source, according to a second embodiment of the present invention; and

FIG. 3 is a sectional view showing a fluorescent lamp of a fluorescent light source, according to a third embodiment of the present invention.

### DESCRIPTION OF THE REFERENCE NUMERALS IN THE DRAWINGS

10: glass 20: fluorescent material

30: electrical discharge part 40: yttria layer

### BEST MODE FOR CARRYING OUT THE INVENTION

Hereinafter, a detailed description will be given of the present invention, in conjunction with the appended drawings.

A fluorescent light source of the present invention comprises glass, a fluorescent material layer, and an absorbing layer composed mainly of yttria, which is formed between the glass and the fluorescent material layer or on the inner surface of the fluorescent material layer.

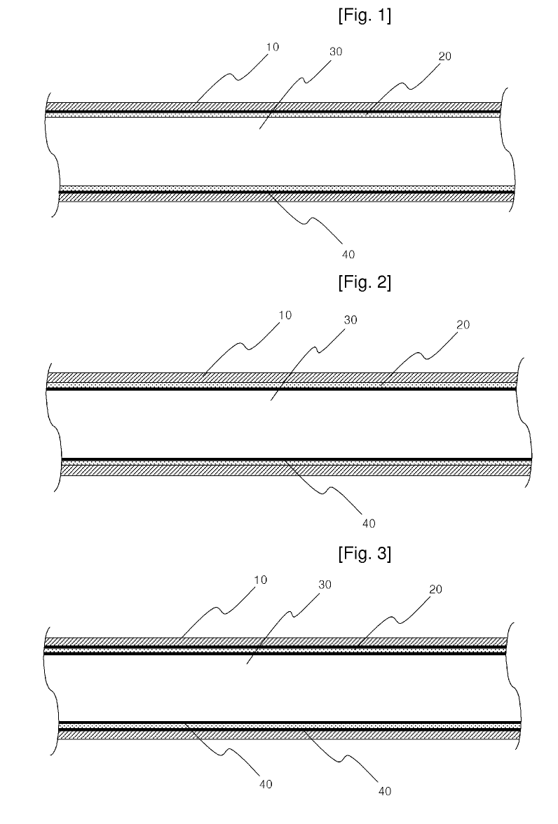

That is, the present invention discloses a technique for attaching yttria to the inner surface of glass of the fluorescent light source or to the inner surface of the fluorescent material layer of the light source to form a protective film, as shown in FIGS. 1 to 3.

Thereby, the fluorescent light source can have a lifetime of 50,000 hr or longer.

In the present invention, a material for an absorbing layer for use in protection of the fluorescent material or glass should have 1) the ability to penetrate UV light at a predetermined wavelength for the emission of a fluorescent material, and 2) the ability to prevent the diffusion of mercury. For good emission of a fluorescent material, the material for an absorbing layer should penetrate UV light at a wavelength of 254 nm, which is a bright line of mercury, and block UV light at a wavelength of 185 nm or less, which ages fluorescent material. However, when light at 365 nm is blocked, visible blue light is also blocked, thus decreasing the properties of a blue fluorescent material. Hence, a material which blocks UV light at 330 nm or less should be used.

In addition, to satisfy the requirement for mercury impermeability, a material should be stable in an electrical discharge space, and the material itself should not deteriorate, and should impermeate mercury.

Thus, as the material for an absorbing layer satisfying the above requirements, yttria (Y₂O₃) is used in the present invention.

When the absorbing layer formed of yttria is applied between the glass and the fluorescent material layer of the light source, glass is protected from exposure to UV light at a wavelength of 185 nm or less, and mercury is not diffused into glass, to control the aging of glass. When the absorbing layer is applied on the surface of the fluorescent material layer, the fluorescent material and glass are protected from exposure to UV light at 185 nm or less, and a bright line of mercury is permeated to induce the emission of the fluorescent material. While the diffusion of mercury into the fluorescent material and glass is prevented, thus controlling the aging of the fluorescent material and glass. In particular, the application of the absorbing layer as mentioned above positively affects blue fluorescent material which is easily aged by the increased emission of UV light at 185 nm or less. As well, the absorbing layer functions to pass light at 365 nm therethrough, and is formed of yttria particles to resist absorption of the visible light range. Also, initial luminance is not decreased, thanks to the application of the absorbing layer, through which the bright line of mercury for emission of a fluorescent material is passed.

The yttria particles used in the absorbing layer of the present invention have a maximum diameter not exceeding 1000 nm. If the maximum diameter exceeds 1000 nm, the luminance properties of the fluorescent light source may be decreased. It is preferable that the average particle size of yttria be small. For preparation in practice, yttria preferably has an average particle size ranging from 100 to 500 nm.

Further, the absorbing layer composed mainly of yttria is 50 to 1000 nm thick. If the layer thickness is less than 50 nm, the layer does not exhibit an absorption function and a diffusion prevention function. On the other hand, if the thickness exceeds 1000 nm, luminance properties may be decreased.

Yttria may be applied on the inner surface of glass of the fluorescent light source or on the inner surface of the fluorescent material layer, according to a typical process known in the art, for example, a coating process, a sputtering process, or a vacuum deposition process, such as CVD. Particularly, a composition containing yttria may be easily attached to the inner surface of glass or to the inner surface of the fluorescent material, using a coating process.

Thus, the present invention provides an yttria coating composition for a fluorescent light source, comprising yttria, having a maximum particle size not exceeding 1000 nm, and a dilution solvent.

Yttria used in the coating composition of the present invention is preferably yttria nano-powder, which results from burning of a metal compound obtained through a chemical reaction of a starting material of elemental yttrium.

Specifically, yttria is obtained by subjecting a starting material, such as a soluble yttrium salt, including yttrium nitrate, yttrium chloride or yttrium acetate; yttrium alkoxide, soluble in an organic solvent, including yttrium isopropoxide; or an yttrium compound, insoluble in water, including yttrium carbonate, yttrium hydroxide, yttrium sulfate, yttrium oxalate or yttrium oxide, to a known chemical reaction, to obtain a metal compound of yttrium oxide, yttrium carbonate or yttrium hydroxide, which is then burned.

As such, as a burning process, a low-temperature burning process is preferably adopted to minimize the agglomeration of particles and obtain nano-particles. In particular, since the oxidation temperature of yttria is 500° C., a burning process is preferably conducted at 600˜900° C. In addition, with the goal of easily oxidizing yttria and shortening the process time, a burning process is more preferably conducted at 600˜900° C. for 5˜200 min in an oxidation atmosphere, such as oxygen gas.

To prepare nano-particles of the burned yttria, a milling process may be conducted, which is classified into a dry milling process, using a jet mill, and a wet milling process, using a bead mill.

When the yttria thus prepared is contained in the coating composition of the present invention, its average particle size should be very small. In particular, the average particle size of yttria preferably ranges from 100 to 500 nm, to assure the luminance of the fluorescent light source.

Although the content of yttria is not particularly limited in the present invention, it is preferably contained in the coating composition in an amount of 0.1˜10 wt %, in consideration of easy handling of a suspension, and more preferably, is contained in an amount of 3˜6 wt %, for dispersion and coating workability.

The solvent included in the coating composition to dilute the yttria includes an aqueous solution or an organic solvent, for example, water, methanol, ethanol, propanol, isopropanol, butanol, or isobutanol.

The yttria and the solvent contained in the coating composition of the present invention may be mixed together, with dispersion or stirring, using a typical means, such as a stirrer, a homogenizer, an ultrasonic distributor, a ball mill, or a bead mill. In particular, a wet distributor, such as a ball mill or a bead mill, may be preferably used, so that yttria is dispersed in the form of particles having a maximum particle size of 1000 nm or less.

In addition, the yttria coating composition for a fluorescent light source of the present invention, which includes yttria and a dilution solvent, may further comprise a binder, a dispersant, etc., if necessary.

The binder functions to attach yttria particles to the coating surface.

The binder includes a generally used organic binder or inorganic binder, for example, a cellulose-based organic binder, such as nitrocellulose, or ethylcellulose, for improvement in adhesion upon a coating process, and a silica-based inorganic binder, such as TEOS, MTMS, MTES, or HMDS, for improvement in adhesion after a coating process. Moreover, when a mixture comprising an organic binder and an inorganic binder is used, adhesion may be further increased upon a coating process and after a coating process. As such, the organic binder and the inorganic binder are mixed at a ratio ranging from 100:1 to 1:50.

The binder is included in the coating composition in an amount of 0.01˜5 wt %.

When the binder is used in the above range, adhesion and luminance may be prevented from decreasing.

In addition, the dispersant functions to easily disperse the yttria in the composition, and prevent the agglomeration of the composition.

The dispersant includes various known dispersants for slurry, for example, an alkylolammonium salt of a block copolymer having a water-soluble acid group.

The dispersant is included in the coating composition in an amount of 0.1˜10 wt %. When the dispersant is used in the above range, the dispersibility of yttria improves.

Further, the dispersant is added to easily disperse the yttria particles and prevent the agglomeration of the particles, and includes various known dispersants for slurry, for example, an alkylolammonium salt of a block copolymer having a water-soluble acid group.

The yttria coating composition for a fluorescent light source thus obtained has a basicity of pH 8˜11 to maintain appropriate dispersion.

In addition, the present invention provides a method of fabricating a fluorescent light source, comprising coating an inner surface of glass of the fluorescent light source or an inner surface of a fluorescent material layer thereof with the yttria coating composition, to form a coating layer, which is then heat treated and cured. As such, the yttria coating layer may be positioned between the glass and the fluorescent material layer, on the inner surface of the fluorescent material layer, or between the glass and the fluorescent material layer and on the inner surface of the fluorescent material layer.

In the case where a glass tube is coated with the coating composition, various known processes may be conducted. For instance, there is a spraying process. Alternatively, the glass tube may be loaded into a container containing the coating composition to stand using a jig, and one end of a rubber tube, the other end of which is connected to a vacuum device, is connected to the upper portion of the glass tube, after which a vacuum is applied to the glass tube, so that the composition is drawn upwards along the inner surface of the glass tube. When the composition reaches a predetermined height, the vacuum is gradually released so that the composition is allowed to flow downwards along the glass tube. In addition, in the case where a flat glass sheet is coated with the coating composition, a known process, such as a spraying process or a coating process, may be used.

The yttria coating layer thus formed is heat treated and dried according to a typical process. After the drying process, the yttria coating layer is preferably 50 to 1000 nm thick. When the coating layer has the thickness in the above range, it can function as an absorbing layer and a diffusion preventing layer, and can prevent the decrease in luminance properties.

The fluorescent light source comprising the absorbing layer composed mainly of yttria may be formed in various known shapes using a fluorescent material and an electrical discharge phenomenon. Specifically, the light source includes, for example, fluorescent light sources or illumination systems, such as general fluorescent lamps, CCFLs, EEFLs, FPLs, lamps for display devices, etc.

In addition, the present invention provides a light source device, comprising the fluorescent light source of the present invention. The light source device is a light supply module including a light source, and is exemplified by linear light source devices or planar light source devices, including a backlight unit applied to TFT-LCD monitors or TFT-LCD TVs.

In addition, the present invention provides a display device including the fluorescent light source of the present invention, or a display device including the light source device. The display device includes all industrial or home display devices requiring a light source, for example, color display devices, flat panel display devices, TFT-LCD monitors or TFT-LCD TVs.

### Mode for the Invention

Hereinafter, the present invention is specifically explained using the following examples which are set forth to illustrate, but are not to be construed to limit the present invention.

### EXAMPLE 1

### Preparation of Yttria Particles

To prepare yttria nano-particles, yttrium nitrate was used as a starting material of yttrium, and ammonium carbonate was used as a starting material of carbonate, and then allowed to react in a liquid state, thus obtaining yttrium carbonate.

Specifically, 1 mol/L aqueous yttrium nitrate solution was added with 1.5 mol/L aqueous ammonium carbonate solution to prepare an yttrium precursor, which was then washed with ultrapure water until NO³⁻ ions were not detected, to obtain a desired precursor. The precursor thus obtained was dried at 100˜150° C. for 12 hr.

The dried material was loaded into an alumina furnace, burned at 800° C. for 30 min in an oxygen atmosphere, and then milled and sorted, thus preparing final nanopowder.

The powder thus prepared was analyzed using an X-ray diffractive process for phase identification, which was thus confirmed to be yttria having a particle size ranging from 500 to 2000 nm.

The particle surface of the powder was observed using a scanning electron microscope, thereby monitoring particle boundaries of yttria. In a particle size distribution obtained by measuring a first particle size of yttria surrounded by particle boundaries, a median value was 30 nm, and a maximum value was 60 nm. According to a BET process, a specific surface area was 35 □/g.

### EXAMPLE 2

### Preparation of Yttria Particles

Nano-powder was prepared in the same manner as in Example 1, with the exception that ammonia water was used as a starting material of hydroxide, instead of the starting material of carbonate, and then allowed to react in a liquid state, thus obtaining yttrium hydroxide.

The powder thus prepared was analyzed using an X-ray diffractive process for phase identification, which was thus confirmed to be yttria having a particle size ranging from 1 to 2 □.

The particle surface of the powder was observed using a scanning electron microscope, thereby monitoring particle boundaries of yttria. In a particle size distribution obtained by measuring a first particle size of yttria surrounded by particle boundaries, a median value was 80 nm, and a maximum value was 200 nm. According to a BET process, a specific surface area was 15 □/g.

### EXAMPLE 3

### Preparation of Yttria Coating Composition for Fluorescent Light Source

500 g of yttria powder prepared in each of Examples 1 and 2, 3000 g of anhydrous ethyl alcohol containing 50 g of ethylcellulose (25° C., 45 cP) dissolved therein, 1500 g of isopropyl alcohol, and 3000 g of isobutyl alcohol were admixed, sufficiently stirred, and then dispersed using a wet bead mill to be uniformly mixed. The resultant mixture was added with ethyl alcohol, to prepare a 5 wt % yttria coating composition having a viscosity of 10 cP and a pH of 9±1.

The particle size distribution of the coating composition thus prepared was measured using a laser diffractive process. As a measurement result, particles had a median value of 250±20 nm, and particles having a maximum value of 1000 nm or more were not observed.

### EXAMPLE 4

### Preparation of Yttria Coating Composition for Fluorescent Light Source

A 5 wt % yttria coating composition having a viscosity of 10 cP or less and a pH of 9±1 was prepared in the same manner as in Example 3, with the exception that 3000 g of anhydrous ethyl alcohol containing 50 g of ethylcellulose (25° C., 45 cP) and 50 g of Disperbyk-180 dissolved therein were used, instead of 3000 g of anhydrous ethyl alcohol containing 50 g of ethylcellulose (25° C., 45 cP) dissolved therein.

As a result of measuring a particle size distribution of the coating composition thus prepared using a laser diffractive process, particles had a median value of 150±20 nm, and particles having a maximum value of 600 nm or more were not observed.

### EXAMPLE 5

### Fabrication of Fluorescent Light Source using Vacuum Device

A washed glass tube was stood using a jig in a container containing the yttria coating composition prepared in Example 3 or 4. Subsequently, one end of a rubber tube, the other end of which was connected to a vacuum device, was connected to the upper portion of the glass tube, after which a vacuum was applied to the glass tube, so that the yttria coating composition prepared in Example 3 or 4 was drawn upwards along the inner surface of the glass tube. When the composition reached a predetermined height, the vacuum was gradually released, so that the yttria coating composition prepared in Example 3 or 4 was allowed to flow downwards along the glass tube. Thereby, a coating layer was formed between a glass bulb and a fluorescent material. Thereafter, the coating layer was dried at 120° C., and the fluorescent material was coated using the vacuum device. The subsequent procedures were conducted in the same manner as is a conventional method of fabricating a light source using a glass tube.

The light source thus fabricated was confirmed to resist blackening by UV light and mercury, resist aging of the fluorescent material upon exposure to UV light of 185 nm, and prevent a decrease in luminous efficiency of the fluorescent material by mercury adsorption, compared to a light source having no coating layer. From this result, the lifetime of the fluorescent light source having yttria attached thereto was seen to be prolonged to 70,000 hr or longer.

### EXAMPLE 6

### Fabrication of Fluorescent Light Source using Sprayer

The yttria coating composition prepared in Example 3 or 4 was sprayed onto a 0.7 mm thick glass sheet at an air pressure of 1˜1.5 kg/□ using a spray gun having a nozzle diameter of 0.2 mm, to form a 1˜2 □ thick coating layer. Subsequently, the glass sheet having the coating layer formed thereon was loaded into a drying oven to dry it, after which the upper surface of the coating layer was coated with fluorescent slurry in a spraying manner. The subsequent procedures were conducted in the same manner as is a conventional method of fabricating a flat panel lamp.

The planar light source thus fabricated was confirmed to resist blackening by UV light and mercury, resist aging of the fluorescent material upon exposure to UV light of 185 nm, and prevent a decrease in luminous efficiency of the fluorescent material by mercury adsorption, compared to a planar light source having no coating layer. From this result, the lifetime of the fluorescent light source having yttria attached thereto was seen to be prolonged to 70,000 hr or longer.

### INDUSTRIAL APPLICABILITY

As described hereinbefore, the present invention provides a fluorescent light source, an yttria coating composition for the fluorescent light source, and a method of fabricating the fluorescent light source. According to the present invention, inorganic yttria, which passes a bright line of mercury, required for the emission of a fluorescent material among all wavelengths of light emitted by electrical discharge, absorbs a UV wavelength range decreasing the lifetime of the fluorescent material, and minimizes the absorption of visible blue light, is used in an absorbing layer in the form of particles. Thereby, while initial luminance properties of the fluorescent light source are not decreased, the lifetime of the fluorescent light source is prolonged to 50,000˜70,000 hr.

In addition, the yttria layer functions to prevent the diffusion of mercury into glass in an electrical discharge tube, thus prohibiting the reaction between mercury and sodium included in the glass. Thereby, the reaction between sodium and mercury, acting as the cause of a blackening phenomenon, does not occur, and thus, the lifetime of the fluorescent light source can be prolonged.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fluorescent light source, comprising glass, a fluorescent material layer, and an absorbing layer composed mainly of yttria (Y₂O₃), which is formed between the glass and the fluorescent material layer or on an inner surface of the fluorescent material layer.

2. The light source according to claim 1, wherein the yttria is in the form of nano-particles having a maximum particle size not exceeding 1000 nm.

3. The light source according to claim 1, wherein the absorbing layer composed mainly of yttria is 50 to 1000 nm thick.

4. An yttria coating composition for a fluorescent light source, comprising yttria, having a maximum particle size not exceeding 1000 nm, and a dilution solvent.

5. The coating composition according to claim 4, wherein the yttria coating composition for a fluorescent light source comprises 0.1-10 wt % yttria, with the balance being the dilution solvent.

6. The coating composition according to claim 4, further comprising 0.01-5 wt % binder, including a cellulose-based organic binder and a silica-based inorganic binder mixed at a ratio of 100:1-1:50.

7. The coating composition according to claim 4, further comprising 0.1-10 wt % dispersant, which is an alkylolammonium salt of a block copolymer having an acid group.

8. The coating composition according to claim 4, wherein the yttria coating composition has a basicity of pH 8-11.

9. A method of fabricating a fluorescent light source, comprising: a) coating an inner surface of glass of a fluorescent light source or an inner surface of a fluorescent material layer of the fluorescent light source with the yttria coating composition of claim 4, to form a coating layer; and b) heat treating the coating layer to be cured.

10. The method according to claim 9, wherein the coating layer is 50-1000 nm thick.

11. A fluorescent light source, fabricated using the method of claim 9.

12. A light source device, comprising the fluorescent light source of claim 1.

13. A display device, comprising the fluorescent light source of claim 1.

14. A light source device, comprising the fluorescent light source of claim 11.

15. A display device, comprising the fluorescent light source of claim 11.
